(19) United States
(12) Patent Application Publication
(10) Pub. No.: US 2018/0133718 A1
(43) Pub. Date: May 17, 2018

(54) LUBRICANT PACK FOR A PAPER SHREDDER

(71) Applicant: Hsiang Hsi WANG, Taipei City (TW)

(72) Inventor: Hsiang Hsi WANG, Taipei City (TW)

(21) Appl. No.: 15/351,544

(22) Filed: Nov. 15, 2016

(51) Int. Cl. B02C 18/16; B02C 18/00

(52) U.S. Cl. CPC B02C 18/16; B02C 2018/166; B02C 18/0007

(57) ABSTRACT

Disclosed herein is a lubricant pack for a paper shredder, which includes two covering layers disposed side-by-side and edges thereof are thermally welded to form a sealed bag. Lubricant is enclosed in the bag, at least one breach is formed at least one side of the edges, and the breach is partially connected with the corresponding edge. As such, air contained in the lubricant tends to be released from the breach so that the lubricant squirting can't happen during the lubrication process.

### FIELD OF THE INVENTION

The present invention is related to a paper shredder, and more particularly to a lubricant pack for a paper shredder, wherein the lubricant can be contacted with cutting blades for the purpose of lubrication during the breaking of the lubricant pack in the paper shredder.

### BACKGROUND OF THE INVENTION

As we all know, when a paper shredder works, multiple cutting blades inserted through two parallel rotary shafts cut passing papers into pieces or chips by rotation of the rotary shafts powered by a motor and a gear box. During the cutting process, friction of the metallic cutting blades results in high temperature. After long-term use, the efficiency of the cutting blades reduces, and the noise generated by the cutting blades increases, so that the entire operation life of the paper shredder lowers. Therefore, it is necessary to maintain and lubricate the cutting blades of the paper shredder.

In the first generation lubricant pack, a lubricant-soaked paper is sandwiched in between two oil-proof covering layers, or the lubricant is directly packed in the two covering layers without the paper. However, when the lubricant pack passes through cutting blades of a paper shredder, air contained in the lubricant squirts out of the pack because of compression. This may shock the user standing nearby, and lead to lubricant pollution of surroundings.

In order to solve the foregoing squirting problem, the second generation lubricant pack is disclosed in U.S. Pat. No. 7,793,876. The lubricant pack is sealed at its edges with an inner seal and an outer seal, and vents are formed between the two seals.

The third generation lubricant pack is presented in U.S. Pat. No. 9,239,132. This lubricant pack not only has two seals and vents as described in the second generation one, but also is sealed at the center thereof with a cruciform seal to separate the original big packet into several small packets.

The fourth generation lubricant pack is revealed in U.S. patent application Ser. No. 14/471,662. The lubricant pack is sealed at its edges, and an interior seal of the lubricant pack is separated into at least one interior region. Any peripheral region and the interior region are not linked with each other to form independent regions, and the independent regions are filled with the lubricant. This can prevent pooling of the lubricant resulted from precipitation.

A lubricant pack for a paper shredder is disclosed in China Utility Patent Application No. 200820044342.3. The lubricant pack comprises a sandwich bag made of composite papers, and the lubricant is packed in the bag. The bag is sealed at its edges with a seal rim so as to form an accommodating bag for the lubricant. Multiple short seal rims are mounted between the seal rims and the edges of the sandwich bag for preventing the squirting of the lubricant therein.

All of the foregoing lubricant packs have distinct structural features, but their objectives are the same, to provide the desirable lubrication effect for the cutting blades of the paper shredder and to prevent the squirting and pooling problems. However, they all have complicated structural features and are made via complex fabrication procedures, so each has a high production cost. The inventor therefore makes efforts to create a lubricant pack for a paper shredder, and the lubricant pack has a simple structural feature and is made via convenient fabrication procedures to become a product with a high cost-performance (CP) ratio.

### SUMMARY OF THE INVENTION

After long-term investigation, the inventor proposes that an easy way to overcome the squirting problem is to configure stress concentrators at an appropriate location of a lubricant pack. According to continuum mechanics, a stress means force endured on unit area. In other words, the smaller the unit area is, the greater the stress is. Thereby, the stress concentrators are ready to be breakdown points. Such theory is applied in a lubricant pack for a paper shredder so that multiple stress concentrators are designed at an appropriate location of the lubricant pack. When the designed stress concentrators of the lubricant pack pass through cutting blades of the paper shredder, compressed air contained in the lubricant is released from these open regions to give the desirable lubrication effect to the cutting blades without lubricant squirting.

Therefore, an objective of the present invention is to provide a lubricant pack for a paper shredder, wherein multiple stress concentrators are configured at an appropriate location. When the lubricant pack passes through the cutting blades of the paper shredder, the stress concentrators continuously pass through the cutting blades. In such a way, compressed air contained in the lubricant is released from these stress concentrators, which cannot result in the lubricant squirting during the lubrication for the cutting blades.

For achieving the above and/or other objective(s), a lubricant pack for a paper shredder is presented in the present invention, which includes two covering layers disposed side-by-side and edges thereof are thermally welded to form a sealed bag. Lubricant is enclosed in the bag, at least one breach is formed at least one side of the edges, and the breach is partially connected with the corresponding edge. By such a structure, air contained in the lubricant tends to be released from the breach so that the lubricant squirting can't happen during the lubrication process.

In a preferable embodiment of the present invention, the breach is in a geometrical shape.

In another preferable embodiment of the present invention, the breach is in an isosceles triangle.

### BRIEF DESCRIPTION OF THE DRAWINGS

FIG. 1 is a structural diagram illustrating a first embodiment of the present invention; and

FIG. 2 is a structural diagram illustrating a second embodiment of the present invention.

### DETAILED DESCRIPTION OF THE INVENTION

Further characteristics of the present invention are discussed below by reference to the embodiments in conjunction with the accompanying drawings.

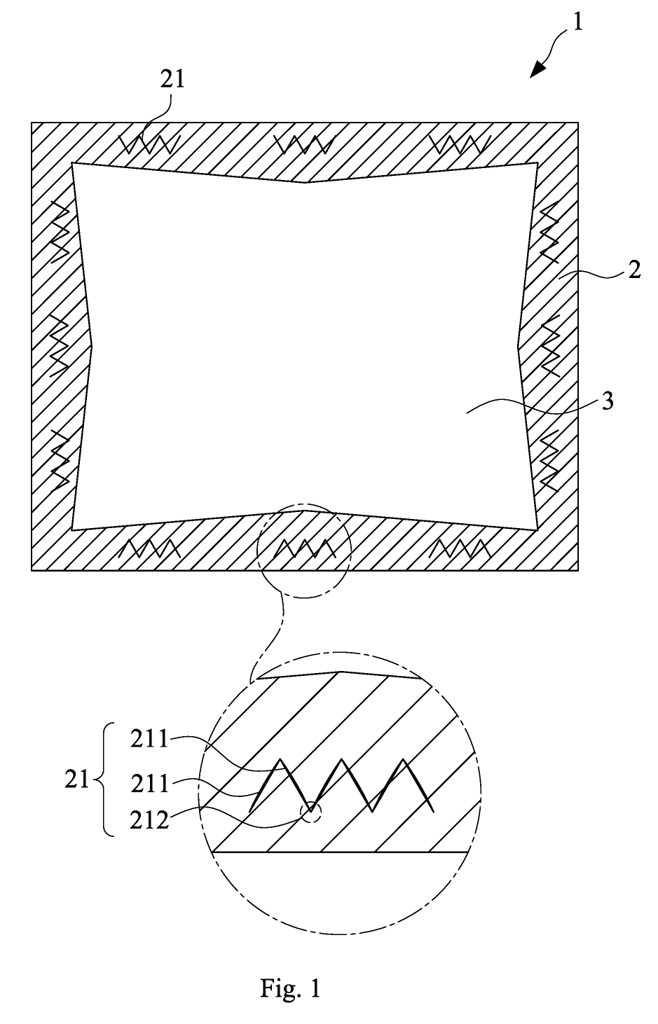

As shown in FIG. 1, a lubricant pack (1) according to a first embodiment of the present invention is depicted, which includes two covering layers disposed side-by-side and edges (2) of the covering layers are thermally welded to form a sealed bag (3). Lubricant (not shown) is enclosed within the bag (3). The present embodiment is characterized that at least one breach (21) is formed at least one side of the edges (2), and the breach is partially connected with the corresponding edge (2).

According to the partially magnified view in FIG. 1, the breach (21) is in a geometrical shape, i.e. an isosceles triangle. The two legs (equal sides) of the isosceles triangle are separated from the corresponding edge to from a separation portion (211), and the base and the base angles (angles having the base) thereof are connected with the corresponding edge (2) to form a connection portion (212). As a paper shredder cuts the lubricant pack, air contained in the lubricant tends to be released from the separation portion (211) of the breach (21).

In the embodiment, the breach (21) is in an isosceles triangle, but it may be in another geometrical shape, e.g. a cruciform, a circle, a rectangle, or a polygon.

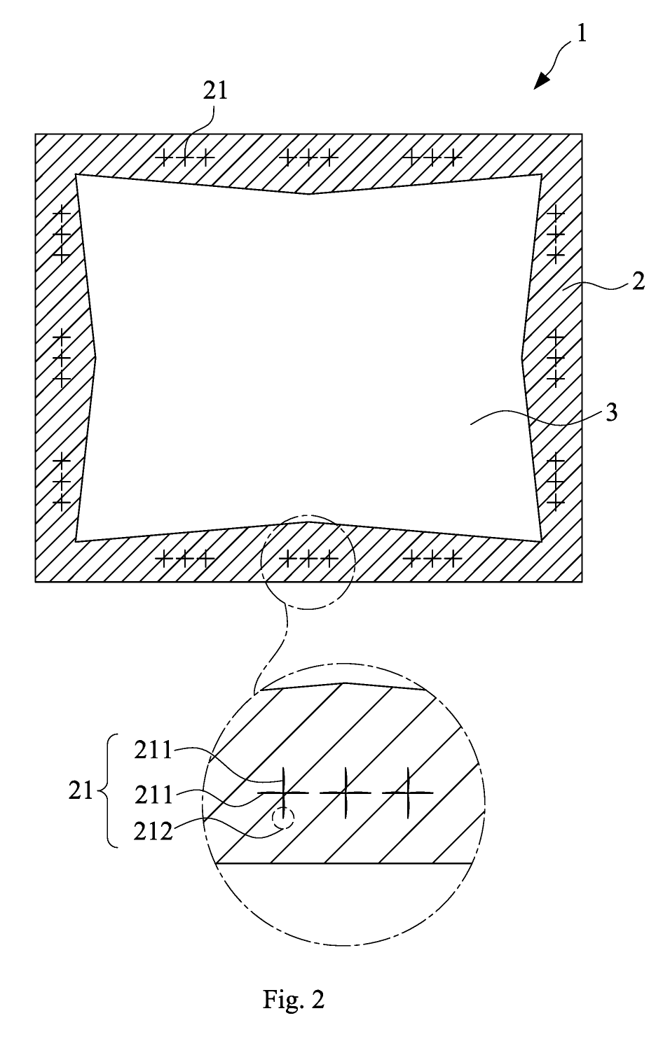

As shown in FIG. 2, the breach (21) is in another geometrical shape, i.e. a cruciform. The center of the cruciform is separated from the corresponding edge to form a separation portion (211), and the ends thereof are connected with the corresponding edge (2) to form a connection portion (212). When a paper shredder cuts the lubricant pack, air contained in the lubricant tends to be released from the separation portion (211) of the breach (21).

As above, the present invention is featured that stress concentrators are configured in the lubricant pack. When the stress concentrators of the lubricant pack pass through the cutting blades of a paper shredder, compressed air contained in the lubricant is released from these stress concentrators. As such, lubricant squirting can't take place during the lubrication of the cutting blades. In summary, the present invention provides a lubricant pack having a simple structural feature and made via convenient fabrication procedures, brings a desirable lubrication effect to the cutting blades of a paper shredder, and avoids lubricant squirting. That is, those skilled in this art can acknowledge the present invention as unobvious over those prior lubricant packs. While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lubricant pack for a paper shredder comprising:
two covering layers disposed side-by-side;
wherein edges of the two covering layers are at least one seal around their peripheries to form a sealed bag;
the lubricant is enclosed in the sealed bag;
at least one breach is formed at least one side of the edges; and
the breach is partially connected with the corresponding edge.

2. The lubricant pack as claimed in claim 1, wherein the breach is in a geometrical shape.

3. The lubricant pack as claimed in claim 1, wherein the breach is in an isosceles triangle, two legs of the isosceles triangle are separated from the corresponding edge to form a separation portion, and a base and base angles of the isosceles triangle are connected with the corresponding edge to form a connection portion.

4. The lubricant pack as claimed in claim 1, wherein the breach is in a cruciform, a center of the cruciform is separated from the corresponding edge to form a separation portion, and ends of the cruciform are connected with the corresponding edge to form a connection portion.
